(19) United States
(12) Patent Application Publication
(10) Pub. No.: US 2025/0323541 A1
(43) Pub. Date: Oct. 16, 2025

(54) PERMANENT MAGNET-TYPE ROTARY ELECTRIC MACHINE DRIVING SYSTEM AND PERMANENT MAGNET-TYPE ROTARY ELECTRIC MACHINE DRIVING METHOD

(71) Applicant: Mitsubishi Electric Corporation, Tokyo (JP)

(72) Inventors: Junji KITAO, Tokyo (JP); Tomohira TAKAHASHI, Tokyo (JP); Takahiro MIZUTA, Tokyo (JP)

(73) Assignee: Mitsubishi Electric Corporation, Tokyo (JP)

(21) Appl. No.: 18/862,976

(22) PCT Filed: Jun. 2, 2022
(86) PCT No.: PCT/JP2022/022480

§ 371 Date: Nov. 5, 2024

(51) Int. Cl. H02K 1/276; H02K 21/14

(52) U.S. Cl. CPC H02K 1/276; H02K 21/14; H02K 2213/03

(57) ABSTRACT

An object is to drive a permanent magnet-type rotary electric machine including eddy current suppression members, under such a control condition that can suppress eddy current loss in an entire rotor. A permanent magnet-type rotary electric machine driving system includes: a permanent magnet-type rotary electric machine including a stator having a stator core and a stator coil, and a rotor having a rotor core, a plurality of permanent magnets, and eddy current suppression members; an inverter; and a control device for designating a carrier frequency. The control device designates the carrier frequency greater than a loss cross frequency calculated from formulae using dimensions and physical constants of the permanent magnets and the eddy current suppression members.

### TECHNICAL FIELD

The present disclosure relates to a permanent magnet-type rotary electric machine control system and a permanent magnet-type rotary electric machine control method.

### BACKGROUND ART

In a permanent magnet-type rotary electric machine having permanent magnets in a rotor, eddy current flows through permanent magnets during rotational operation. When eddy current flows through the permanent magnets, resistance increase and temperature increase of the permanent magnets occur due to the eddy current, so that demagnetization occurs, thus causing power loss called eddy current loss. As a conventional rotary electric machine that can suppress eddy current flowing through permanent magnets, a structure in which eddy current suppression members having high conductivity are arranged at outer peripheries of permanent magnets is disclosed (see, for example, Patent Document 1).

### CITATION LIST

### Patent Document

Patent Document 1: Japanese Laid-Open Patent Publication No. 2002-345189

### SUMMARY OF THE INVENTION

### Problem to be Solved by the Invention

However, in the conventional rotary electric machine in which the eddy current suppression members are arranged at the outer peripheries of the permanent magnets, eddy current flows also through the eddy current suppression members, and therefore, depending on a control condition, eddy current loss including those in the permanent magnets and the eddy current suppression members increases.

The present disclosure has been made to solve the above problem, and an object of the present disclosure is to, in a driving system for a permanent magnet-type rotary electric machine including eddy current suppression members, drive the permanent magnet-type rotary electric machine under such a control condition that can suppress eddy current loss including those in permanent magnets and the eddy current suppression members.

### Means to Solve the Problem

A permanent magnet-type rotary electric machine driving system according to the present disclosure includes: a permanent magnet-type rotary electric machine including a stator having an annular-shaped stator core and a stator coil wound at the stator core, and a rotor having a rotor core fastened to a rotary shaft and a plurality of permanent magnets buried in the rotor core; an inverter which outputs driving power to the stator coil; and a control device which designates a carrier frequency for the inverter and controls an output of the inverter. The plurality of permanent magnets are provided so as to be arranged in a circumferential direction, and an eddy current suppression member is provided at a magnetic flux generation surface of at least one of the permanent magnets with an insulating member interposed therebetween. Where, in a cross-section along a plane perpendicular to the rotary shaft, a length in a longitudinal direction of the magnetic flux generation surface of the one permanent magnet is a width d₁, a length in a depth direction of the magnetic flux generation surface of the one permanent magnet is h₁, an electric conductivity of the one permanent magnet is σ₁, a magnetic permeability of the one permanent magnet is μ₁, a length in a longitudinal direction of a surface opposed to the one permanent magnet, of the eddy current suppression member, is a width d₂, a length in a depth direction of the surface opposed to the one permanent magnet, of the eddy current suppression member, is h₂, an electric conductivity of the eddy current suppression member is σ₂, and a magnetic permeability of the eddy current suppression member is μ₂, the control device designates the carrier frequency greater than a frequency f calculated from the following seven formulae:

$$\begin{matrix}[ Mathematical 1 ] & \\ {δ}_{1} = \sqrt{\frac{1}{π f {σ}_{1} {μ}_{1}}} , & \end{matrix}$$

$$\begin{matrix}[ Mathematical 2 ] & \\ {δ}_{2} = \sqrt{\frac{1}{π f {σ}_{2} {μ}_{2}}} , & \end{matrix}$$

$$\begin{matrix}[ Mathematical 3 ] & \\ A ( {d}_{1} / {δ}_{1} ) = \frac{sinh ( {d}_{1} / {δ}_{1} ) + sin ( {d}_{1} / {δ}_{1} )}{cosh ( {d}_{1} / {δ}_{1} ) - cos ( {d}_{1} / {δ}_{1} )} , & \end{matrix}$$

$$\begin{matrix}[ Mathematical 4 ] & \\ A ( {d}_{2} / {δ}_{2} ) = \frac{sinh ( {d}_{2} / {δ}_{2} ) + sin ( {d}_{2} / {δ}_{2} )}{cosh ( {d}_{2} / {δ}_{2} ) - cos ( {d}_{2} / {δ}_{2} )} , & \end{matrix}$$

$$\begin{matrix}[ Mathematical 5 ] & \\ B ( {d}_{1} / {δ}_{1} ) = \frac{sinh ( {d}_{1} / {δ}_{1} ) - sin ( {d}_{1} / {δ}_{1} )}{cosh ( {d}_{1} / {δ}_{1} ) - cos ( {d}_{1} / {δ}_{1} )} , & \end{matrix}$$

$$\begin{matrix}[ Mathematical 6 ] & \\ B ( {d}_{2} / {δ}_{2} ) = \frac{sinh ( {d}_{2} / {δ}_{2} ) - sin ( {d}_{2} / {δ}_{2} )}{cosh ( {d}_{2} / {δ}_{2} ) - cos ( {d}_{2} / {δ}_{2} )} , \\ and & \end{matrix}$$

$$\begin{matrix}[ Mathematical 7 ] & \\ \frac{{h}_{1} {σ}_{1} {δ}_{1} B ( {d}_{1} / {δ}_{1} )}{{\{ \frac{{h}_{1}}{{μ}_{1}} \frac{d}{2 {δ}_{1}} A ( {d}_{1} / {δ}_{1} ) \}}^{2} + {\{ \frac{{h}_{1}}{{μ}_{1}} \frac{d}{2 {δ}_{1}} B ( {d}_{1} / {δ}_{1} ) \}}^{2}} = \frac{{h}_{1} {σ}_{1} {δ}_{1} B ( {d}_{1} / {δ}_{1} ) + {h}_{2} {σ}_{2} {δ}_{2} B ( {d}_{2} / {δ}_{2} )}{\begin{matrix}{\{ \frac{{h}_{1}}{{μ}_{1}} \frac{d}{2 {δ}_{1}} A ( {d}_{1} / {δ}_{1} ) + \frac{{h}_{2}}{{μ}_{2}} \frac{d}{2 {δ}_{2}} A ( {d}_{2} / {δ}_{2} ) \}}^{2} + \\ {\{ \frac{{h}_{1}}{{μ}_{1}} \frac{d}{2 {δ}_{1}} B ( {d}_{1} / {δ}_{1} ) + \frac{{h}_{2}}{{μ}_{2}} \frac{d}{2 {δ}_{2}} B ( {d}_{2} / {δ}_{2} ) \}}^{2}\end{matrix}} . & \end{matrix}$$

### Effect of the Invention

In the permanent magnet-type rotary electric machine driving system according to the present disclosure, since the control device designates the carrier frequency greater than the frequency f calculated from the seven formulae, it is possible to drive the permanent magnet-type rotary electric machine under such a control condition that can suppress eddy current loss including those in the permanent magnets and the eddy current suppression members.

### BRIEF DESCRIPTION OF THE DRAWINGS

FIG. 1 is a sectional view of a permanent magnet-type rotary electric machine according to embodiment 1.

FIG. 2 is an enlarged sectional view of a rotor of the permanent magnet-type rotary electric machine according to embodiment 1.

FIG. 3 is a configuration diagram of a permanent magnet-type rotary electric machine driving system according to embodiment 1.

FIG. 4 is a characteristic graph of eddy current loss in the permanent magnet-type rotary electric machine according to embodiment 1.

FIG. 5 is a characteristic graph showing an example of the relationship between a loss cross frequency and the width of a permanent magnet in the permanent magnet-type rotary electric machine according to embodiment 1.

FIG. 6 is an enlarged sectional view of a rotor of another permanent magnet-type rotary electric machine according to embodiment 1.

FIG. 7 is an enlarged sectional view of a rotor of a permanent magnet-type rotary electric machine according to embodiment 2.

FIG. 8 is an enlarged sectional view of a rotor of a permanent magnet-type rotary electric machine according to embodiment 3.

FIG. 9 is an enlarged sectional view of a rotor of a permanent magnet-type rotary electric machine according to embodiment 4.

FIG. 10 shows a hardware configuration for implementing a control device of the permanent magnet-type rotary electric machine driving system according to each of embodiments 1 to 4.

### DESCRIPTION OF EMBODIMENTS

Hereinafter, a permanent magnet-type rotary electric machine driving system according to embodiments for carrying out the present disclosure will be described in detail with reference to the drawings. In the drawings, the same reference characters denote the same or corresponding parts.

### Embodiment 1

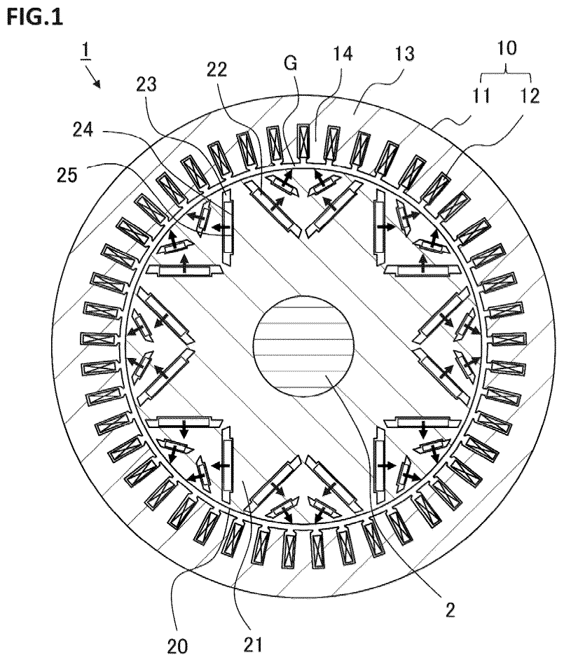

FIG. 1 is a sectional view of a permanent magnet-type rotary electric machine according to embodiment 1. FIG. 1 is a sectional view along a direction perpendicular to the rotary shaft of the permanent magnet-type rotary electric machine. A permanent magnet-type rotary electric machine 1 of the present embodiment includes a rotor 20 fastened to a rotary shaft 2, and a cylindrical stator 10 coaxially provided on the outer circumferential side of the rotor 20. A gap G is formed between the rotor 20 and the stator 10. The stator 10 is retained in a cylindrical frame (not shown) The rotary shaft 2 is supported by a pair of brackets (not shown) via bearings. The pair of brackets are fixed at both ends in the axial direction of the frame.

Here, a direction parallel to the axis of the rotary shaft 2 is referred to as an axial direction, a direction perpendicular to the axis of the rotary shaft 2 is referred to as a radial direction, and a direction in which the rotor 20 rotates about the axis of the rotary shaft 2 is referred to as a circumferential direction.

The stator 10 includes an annular-shaped stator core 11, and a stator coil 12 wound at the stator core 11. The stator core 11 has an annular-shaped core back 13, and a plurality of teeth 14 protruding inward in the radial direction from the inner circumferential surface of the core back 13. Forty-eight teeth 14 are arranged at equal intervals in the circumferential direction. The stator coil 12 is wound at the stator core 11 by distributed winding across a plurality of the teeth 14.

The rotor 20 has a rotor core 21 having a rotary shaft insertion hole into which the rotary shaft 2 is inserted, and thirty-two permanent magnets 22 buried in the rotor core 21. The rotor core 21 is fastened to the rotary shaft 2 inserted into the rotary shaft insertion hole. In FIG. 1, arrows shown at the permanent magnets 22 indicate the directions of magnetic fluxes generated from the permanent magnets 22. The stator core 11 and the rotor core 21 are formed by electromagnetic steel sheets stacked in the axial direction, for example.

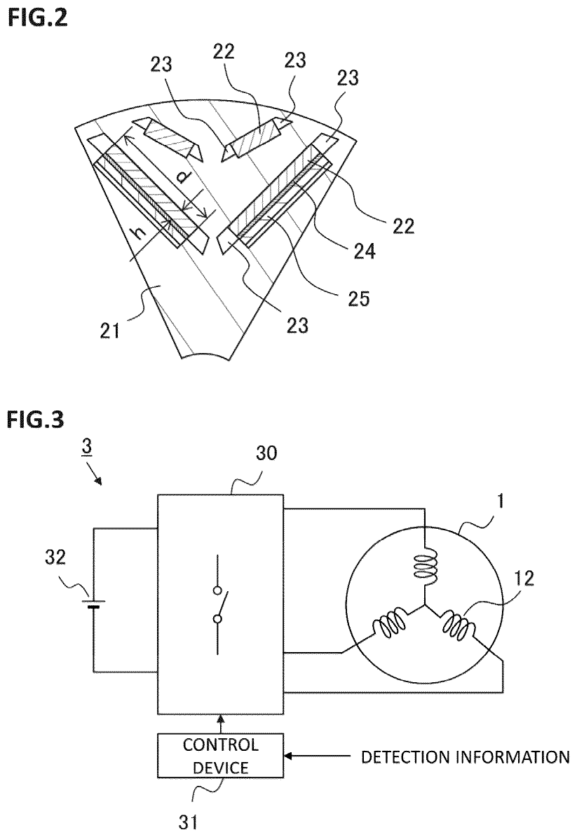

FIG. 2 is an enlarged sectional view of one magnetic pole of the rotor of the permanent magnet-type rotary electric machine according to the present embodiment. FIG. 2 is a sectional view along a direction perpendicular to the rotary shaft of the permanent magnet-type rotary electric machine. In the rotor 20 of the present embodiment, one magnetic pole is formed of four permanent magnets 22. One magnetic pole has a two-layer structure in which pairs of two permanent magnets 22 are arranged in V shapes. Of the pairs of two permanent magnets 22 arranged in V shapes, the permanent magnets 22 on the outer circumferential side are defined as a first layer, and the permanent magnets 22 on the inner circumferential side are defined as a second layer. At both ends of each permanent magnet 22, flux barriers 23 having a smaller magnetic permeability than the magnetic permeability of the rotor core 21 are formed. In the permanent magnet-type rotary electric machine 1 of the present embodiment, each flux barrier 23 is formed as a through hole penetrating the rotor core 21 in the axial direction. In the permanent magnet-type rotary electric machine 1 of the present embodiment, the flux barrier 23 is formed as a part of a magnet storage hole in which the permanent magnet 22 and the like can be stored.

As shown in FIG. 2, an eddy current suppression member 25 is provided on the inner circumferential side of a magnetic flux generation surface of the permanent magnet 22 in the second layer with an insulating member 24 interposed therebetween. The insulating member 24 is made of insulating resin, for example. The eddy current suppression member 25 is made of a material having a greater electric conductivity than those of the permanent magnet 22 and the rotor core 21, e.g., copper or aluminum. In the sectional view shown in FIG. 2, a length in the longitudinal direction of the magnetic flux generation surface of the permanent magnet 22 is defined as a width d, a length in the depth direction of the magnetic flux generation surface of the permanent magnet 22 is defined as a height h, and the length in the axial direction of the permanent magnet 22 is defined as a thickness a. The dimensions of the eddy current suppression member 25 are also defined in the same manner.

Since the electric conductivity of the eddy current suppression member 25 is greater than those of the permanent magnet 22 and the rotor core 21, eddy current generated in the rotor 20 is generated most inside the eddy current suppression member 25. The eddy current generated inside the eddy current suppression member 25 can suppress a magnetic field interlinking with the adjacent permanent magnet 22 by a demagnetizing field generating effect thereof. Thus, the eddy current suppression member 25 can suppress eddy current generated in the permanent magnet 22.

FIG. 3 is a configuration diagram of a permanent magnet-type rotary electric machine driving system according to the present embodiment. A permanent magnet-type rotary electric machine driving system 3 of the present embodiment includes the permanent magnet-type rotary electric machine 1, an inverter 30, and a control device 31. The inverter 30 is connected to the permanent magnet-type rotary electric machine 1. A DC power supply 32 is connected to the inverter 30. The DC power supply 32 supplies DC power to the inverter 30. The inverter 30 is controlled by the control device 31. The control device 31 receives detection information such as a rotational position of the rotor 20 of the permanent magnet-type rotary electric machine 1 and current flowing through the stator coil 12. The control device 31 generates command voltage on the basis of the inputted detection information and command values for the rotation speed, torque, and the like, and outputs the command voltage to the inverter 30. The inverter 30 performs switching operation in accordance with the voltage command inputted from the control device 31. In the inverter 30, switching operation is determined through pulse width modulation (PWM) control on the basis of the carrier frequency of a carrier wave and the command voltage transmitted from the control device 31.

Next, in the permanent magnet-type rotary electric machine driving system of the present embodiment, the reason why the eddy current loss in the permanent magnet can be reduced will be described.

In the permanent magnet-type rotary electric machine driving system of the present embodiment, when the permanent magnet is excited in the height direction at an angular frequency ω and an average magnetic flux density B₀, eddy current loss P in the permanent magnet is represented by the following Formula (1). Here, a is the thickness of the permanent magnet, d is the width of the permanent magnet, h is the height of the permanent magnet, σ is the electric conductivity of the permanent magnet, and μ is the magnetic permeability of the permanent magnet. In addition, eddy current loss in the eddy current suppression member can also be represented by Formula (1).

$$\begin{matrix}[ Mathematical 8 ] & \\ P = \frac{a h σ {ω}^{2} {d}^{2} δ {\vert {B}_{0} \vert}^{2}}{8} \frac{sinh ( d / δ ) - sin ( d / δ )}{cosh ( d / δ ) - cos ( d / δ )} & ( 1 )\end{matrix}$$

Here, δ is defined by the following Formula (2).

$$\begin{matrix}[ Mathematical 9 ] & \\ δ = \sqrt{\frac{2}{ω σ μ}} & ( 2 )\end{matrix}$$

By setting a boundary condition in which the average magnetic flux density B₀ is constant, eddy current loss in the permanent magnet 22 and eddy current loss in the eddy current suppression member 25 can be individually calculated using Formula (1) and Formula (2). Eddy current loss is generated also in the rotor core 21, and hereinafter, it is assumed that the magnitude thereof is not influenced by presence/absence of the eddy current suppression member 25. That is, a difference between eddy current loss in the permanent magnet 22 when the eddy current suppression member 25 is absent and the sum of eddy current loss in the permanent magnet 22 and eddy current loss in the eddy current suppression member 25 when the eddy current suppression member 25 is present, is difference of eddy current loss in the entire rotor.

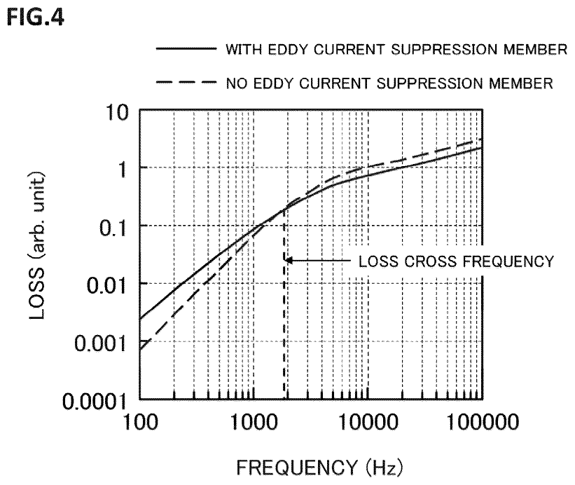

FIG. 4 is a characteristic graph showing eddy current loss in the permanent magnet 22, and the sum of eddy current losses in the permanent magnet 22 and the eddy current suppression member 25, in the permanent magnet-type rotary electric machine of the present embodiment. A solid line indicates the sum of eddy current losses in the permanent magnet 22 and the eddy current suppression member 25 when the eddy current suppression member 25 is present, and a broken line indicates eddy current loss in the permanent magnet 22 when the eddy current suppression member 25 is absent. In FIG. 4, the horizontal axis indicates a frequency, and the vertical axis indicates a relative value of eddy current loss. The frequency on the horizontal axis is represented by ω/2π. In Formula (1) and Formula (2), the Ampere's circuital law is applied and a line integral of a surface magnetic field is set to be constant, whereby a characteristic of eddy current loss with respect to the frequency shown in FIG. 4 is obtained. Here, regarding the permanent magnet 22, the relative permeability μ is 1.05, the electric conductivity σ is 747562 S/m, the thickness a is 10 mm, the width d is 20 mm, and the height h is 6 mm, and regarding the eddy current suppression member 25, the relative permeability μ is 1.0, the electric conductivity σ is 45978465 S/m, the thickness a is 10 mm, the width d is 20 mm, and the height h is 0.3 mm.

As shown in FIG. 4, at frequencies greater than a specific frequency, eddy current loss becomes smaller when the eddy current suppression member is present. However, at frequencies smaller than the specific frequency, eddy current loss becomes greater when the eddy current suppression member is present. The electric conductivity of the eddy current suppression member is greater than the electric conductivity of the permanent magnet. Therefore, in a low frequency region, when the eddy current suppression member is present, eddy current loss in this member is added, so that eddy current loss increases. However, in a high frequency region, a magnetic flux interlinking with the eddy current suppression member is suppressed due to a skin effect, so that eddy current loss in the eddy current suppression member is reduced. As a result, in a high frequency region, the sum of eddy current losses in the permanent magnet and the eddy current suppression member when the eddy current suppression member is present becomes smaller than eddy current loss in the permanent magnet when the eddy current suppression member is absent. Thus, it is found that there is a region of frequencies where eddy current loss in the entire rotor can be reduced by the eddy current suppression member. Here, as shown in FIG. 4, a frequency at an intersection of a curve of eddy current loss when the eddy current suppression member is present and a curve of eddy current loss when the eddy current suppression member is absent, is referred to as a loss cross frequency.

The dimensions and physical constants of the permanent magnet and the eddy current suppression member are defined as follows. Symbols in parentheses represent units.

### <Permanent Magnet>

h₁: height (m)
d₁: width (m)
σ₁: electric conductivity (S/m)
μ₁: magnetic permeability (H/m)

### <Eddy Current Suppression Member>

h₂: height (m)
d₂: width (m)
σ₂: electric conductivity (S/m)
μ₂: magnetic permeability (H/m)

Here, μ₁ and μ₂ are represented by the following two formulae, where μᵣ₁ is the relative permeability of the permanent magnet, μᵣ₂ is the relative permeability of the eddy current suppression member, and po is the vacuum permeability.

$${μ}_{1} =. {μ}_{r 1} \times {μ}_{0} \\ {μ}_{2} =. {μ}_{r 2} \times {μ}_{0}$$

A boundary condition in which the average magnetic flux density B₀ and a line integral of a surface magnetic field are constant is set, and it is assumed that the thicknesses a₁, a₂ of the permanent magnet and the eddy current suppression member are sufficiently greater than the widths d₁, d₂ thereof. The loss cross frequency f at which the sum of eddy current losses in the permanent magnet and the eddy current suppression member when the eddy current suppression member is present, and eddy current loss in the permanent magnet when the eddy current suppression member is absent, are equal to each other, can be calculated from the following Formulae (3) to (6).

Formulae (3) to (5) are calculation formulae for the permanent magnet when n is 1, and are calculation formulae for the eddy current suppression member when n is 2.

$$\begin{matrix}[ Mathematical 10 ] & \\ {δ}_{n} = \sqrt{\frac{1}{π f {σ}_{n} {μ}_{n}}} & ( 3 )\end{matrix}$$

$$\begin{matrix}[ Mathematical 11 ] & \\ A ( {d}_{n} / {δ}_{n} ) = \frac{sinh ( {d}_{n} / {δ}_{n} ) + sin ( {d}_{n} / {δ}_{n} )}{cosh ( {d}_{n} / {δ}_{n} ) - cos ( {d}_{n} / {δ}_{n} )} & ( 4 )\end{matrix}$$

$$\begin{matrix}[ Mathematical 12 ] & \\ B ( {d}_{n} / {δ}_{n} ) = \frac{sinh ( {d}_{n} / {δ}_{n} ) - sin ( {d}_{n} / {δ}_{n} )}{cosh ( {d}_{n} / {δ}_{n} ) - cos ( {d}_{n} / {δ}_{n} )} & ( 5 )\end{matrix}$$

$$\begin{matrix}[ Mathematical 13 ] & \\ \frac{( {h}_{1} {σ}_{1} {δ}_{1} B ( {d}_{1} / {δ}_{1} )}{{\{ \frac{{h}_{1} d}{{μ}_{1} 2 {δ}_{1}} A ( {d}_{1} / {δ}_{1} ) \}}^{2} + {\{ \frac{{h}_{1} d}{{μ}_{1} 2 {δ}_{1} d} B ( {d}_{1} / {δ}_{1} ) \}}^{2}} = \frac{( {h}_{1} {σ}_{1} {δ}_{1} B ( {d}_{1} / {δ}_{1} ) + {h}_{2} {σ}_{2} {δ}_{2} B ( {d}_{2} / {δ}_{2} ) )}{\begin{matrix}{\{ \frac{{h}_{1} d}{{μ}_{1} 2 {δ}_{1}} A ( {d}_{1} / {δ}_{1} ) + \frac{{h}_{2} d}{{μ}_{2} 2 {δ}_{2}} A ( {d}_{2} / {δ}_{2} ) \}}^{2} + \\ {\{ \frac{{h}_{1} d}{{μ}_{1} 2 {δ}_{1} d} B ( {d}_{1} / {δ}_{1} ) + \frac{{h}_{2} d}{{μ}_{2} 2 {δ}_{2}} B ( {d}_{2} / {δ}_{2} ) \}}^{2}\end{matrix}} & ( 6 )\end{matrix}$$

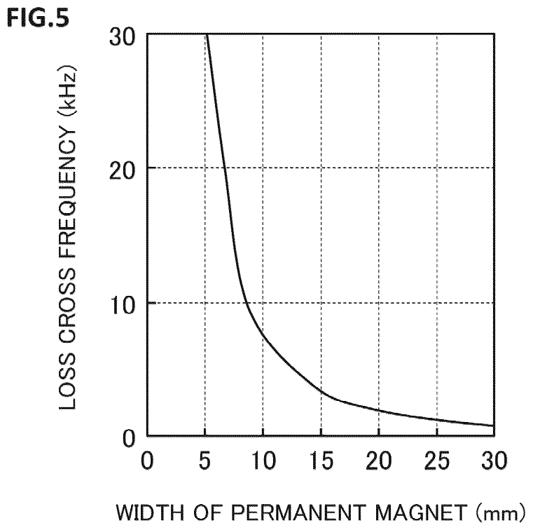

Using the above formulae, the loss cross frequency f with respect to the width d₁ of the permanent magnet is calculated, and the result thereof is shown in FIG. 5. FIG. 5 is a characteristic graph showing an example of the relationship between the width of the permanent magnet and loss cross frequency in the permanent magnet-type rotary electric machine of the present embodiment. In FIG. 5, the horizontal axis indicates the width d₁ of the permanent magnet, and the vertical axis indicates the loss cross frequency. The characteristic shown in FIG. 5 has been calculated under the following condition: h₁=0.006 m, h₂=0.0003 m, σ₁=747562 S/m, σ₂=45978465 S/m, μ₁=1.05 H/m, μ₂=1.0 H/m, and d₁ and d₂ are equal to each other.

When the permanent magnet is excited at a frequency higher than the loss cross frequency determined in accordance with the width of the permanent magnet in FIG. 5, eddy current loss in the entire rotor is smaller in a case where the eddy current suppression member is present. From FIG. 5, it is found that the loss cross frequency greatly changes depending on the magnet width of the permanent magnet. Eddy current flowing through the permanent magnet is a factor for increasing the temperature of the permanent magnet. Therefore, in a case where temperature increase of the permanent magnet is a problem, the carrier frequency in PWM control may be set at a frequency higher than the loss cross frequency while the eddy current suppression member is provided. Specifically, in the permanent magnet-type rotary electric machine shown in FIG. 2, the width of the permanent magnet 22 in the first layer is set at 10 mm, and the width of the permanent magnet 22 in the second layer is set at 20 mm. At this time, in FIG. 5, the loss cross frequency when the width of the permanent magnet is 20 mm is 1.9 kHz. In a case where the eddy current suppression member is provided, if the carrier frequency in PWM control is set at 1.9 kHz or higher, the magnet temperature can be made smaller than in a case where the eddy current suppression member is not provided. Here, examples of measurement methods for the temperature of the permanent magnet include a method of directly measuring the temperature of the permanent magnet during driving, and a method of estimating the magnet temperature from other physical information about the permanent magnet-type rotary electric machine, e.g., the rotation speed or a control elapsed time.

The permanent magnet-type rotary electric machine driving system configured as described above can suppress eddy current loss in the entire rotor by performing driving at a frequency higher than the loss cross frequency determined by the width of the permanent magnet in the second layer.

In the permanent magnet-type rotary electric machine of the present embodiment, the eddy current suppression member is provided only at the permanent magnet in the second layer. In a case where the width of the permanent magnet 22 in the second layer is set at 20 mm, if the carrier frequency is set at 1.9 kHz or higher, eddy current losses in the permanent magnet and the eddy current suppression member in the second layer are reduced. However, in the permanent magnet in the first layer, since this permanent magnet is located close to the gap G, eddy current in a low frequency region occurs due to slot harmonics. The frequency of this eddy current is smaller than the loss cross frequency. Therefore, in the permanent magnet in the first layer, eddy current loss is greater when the eddy current suppression member is provided. For this reason, in the permanent magnet-type rotary electric machine of the present embodiment, the eddy current suppression member is provided only at the permanent magnet in the second layer.

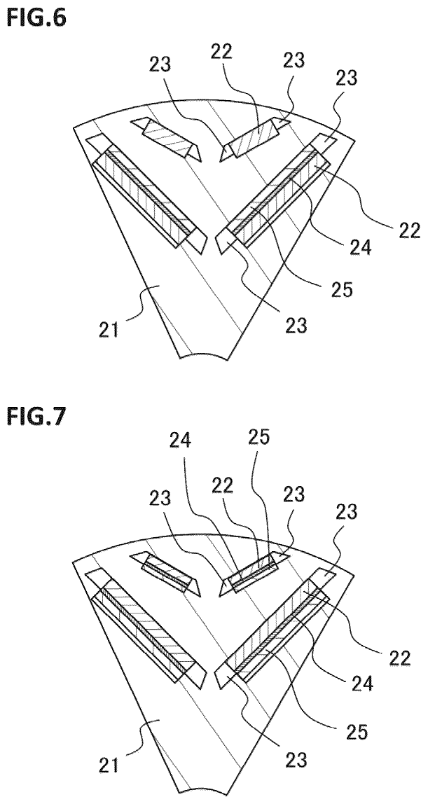

FIG. 6 is an enlarged sectional view of one magnetic pole of a rotor of another permanent magnet-type rotary electric machine according to the present embodiment. In this permanent magnet-type rotary electric machine, the eddy current suppression member 25 is provided on the outer circumferential side of the magnetic flux generation surface of the permanent magnet 22 in the second layer with the insulating member 24 interposed therebetween. As shown in FIG. 2 and FIG. 6, in the permanent magnet-type rotary electric machine according to the present embodiment, if the eddy current suppression member 25 is provided at a position opposed to the magnetic flux generation surface of the permanent magnet 22, it is possible to suppress eddy current loss in the entire rotor by performing driving at a frequency higher than the loss cross frequency. Therefore, the eddy current suppression member 25 may be provided at one or both of surfaces opposed to the magnetic flux generation surface of the permanent magnet 22.

### Embodiment 2

FIG. 7 is an enlarged sectional view of one magnetic pole of a rotor of a permanent magnet-type rotary electric machine according to embodiment 2. The structure of the permanent magnet-type rotary electric machine according to the present embodiment is the same as the structure of the permanent magnet-type rotary electric machine in embodiment 1 except for the structure of the rotor. The configuration of a permanent magnet-type rotary electric machine driving system according to the present embodiment is also the same as the configuration shown in FIG. 3 in embodiment 1.

As shown in FIG. 7, in the permanent magnet-type rotary electric machine according to the present embodiment, the eddy current suppression member 25 is provided on the inner circumferential side of the magnetic flux generation surface of the permanent magnet 22 in the second layer with the insulating member 24 interposed therebetween, and the eddy current suppression member 25 is provided on the inner circumferential side of the magnetic flux generation surface of the permanent magnet 22 in the first layer with the insulating member 24 interposed therebetween.

In the permanent magnet-type rotary electric machine according to the present embodiment, the width of the permanent magnet 22 in the second layer is 20 mm and the width of the permanent magnet 22 in the first layer is 10 mm. From the relationship of the loss cross frequency with respect to the width of the permanent magnet shown in FIG. 5 in embodiment 1, the loss cross frequency when the width of the permanent magnet is 10 mm is 7.7 kHz. In this permanent magnet-type rotary electric machine, if the carrier frequency in PWM control is set at 7.7 kHz or higher, eddy current losses in the permanent magnet and the eddy current suppression member in the first layer can be suppressed, and eddy current losses in the permanent magnet and the eddy current suppression member in the second layer can be suppressed.

As described above, in the permanent magnet-type rotary electric machine driving system of the present embodiment, it is possible to suppress eddy current loss in the entire rotor by performing driving at a frequency higher than the loss cross frequency determined by the width of the permanent magnet in the first layer.

### Embodiment 3

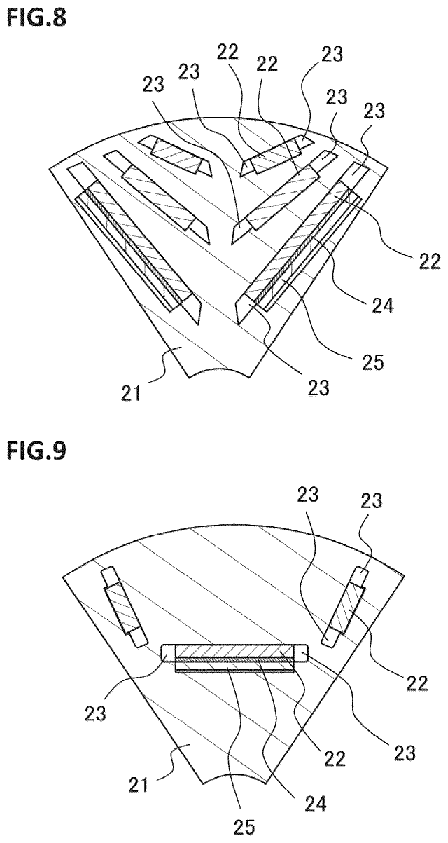

FIG. 8 is an enlarged sectional view showing one magnetic pole of a rotor of a permanent magnet-type rotary electric machine according to embodiment 3. The structure of the permanent magnet-type rotary electric machine according to the present embodiment is the same as the structure of the permanent magnet-type rotary electric machine of embodiment 1 except for the rotor structure. The configuration of a permanent magnet-type rotary electric machine driving system according to the present embodiment is also the same as the configuration shown in FIG. 3 in embodiment 1.

As shown in FIG. 8, in the permanent magnet-type rotary electric machine according to the present embodiment, one magnetic pole is formed of six permanent magnets 22. One magnetic pole has a three-layer structure in which pairs of two permanent magnets 22 are arranged in V shapes. The eddy current suppression member 25 is provided on the inner circumferential side of the magnetic flux generation surface of the permanent magnet 22 in the third layer with the insulating member 24 interposed therebetween.

In the permanent magnet-type rotary electric machine according to the present embodiment, the width of the permanent magnet 22 in the third layer is 20 mm, the width of the permanent magnet 22 in the second layer is 15 mm, and the width of the permanent magnet 22 in the first layer is 10 mm. From the relationship of the loss cross frequency with respect to the width of the permanent magnet shown in FIG. 5 in embodiment 1, the loss cross frequency when the width of the permanent magnet is 20 mm is 1.9 kHz. In this permanent magnet-type rotary electric machine, if the carrier frequency in PWM control is set at 1.9 kHz or higher, eddy current losses in the permanent magnet and the eddy current suppression member in the third layer can be suppressed.

As described above, in the permanent magnet-type rotary electric machine driving system of the present embodiment, it is possible to suppress eddy current loss in the entire rotor by performing driving at a frequency higher than the loss cross frequency determined by the width of the permanent magnet in the third layer.

In the permanent magnet-type rotary electric machine of the present embodiment, one magnetic pole may be formed as a multilayer structure having four or more layers in which pairs of two permanent magnets are arranged in V shapes. In the one magnetic pole formed as a multilayer structure, the eddy current suppression member may be provided at the permanent magnet in the layer on the innermost circumferential side with the insulating member interposed therebetween.

### Embodiment 4

FIG. 9 is an enlarged sectional view of one magnetic pole of a rotor of a permanent magnet-type rotary electric machine according to embodiment 4. The structure of the permanent magnet-type rotary electric machine according to the present embodiment is the same as the structure of the permanent magnet-type rotary electric machine of embodiment 1 except for the structure of the rotor. The configuration of a permanent magnet-type rotary electric machine driving system according to the present embodiment is also the same as the configuration shown in FIG. 3 in embodiment 1.

As shown in FIG. 9, in the permanent magnet-type rotary electric machine according to the present embodiment, one magnetic pole is formed of three permanent magnets 22. One magnetic pole is formed of one permanent magnet 22 on the inner circumferential side which has a magnetic flux generation surface in a direction perpendicular to the radial direction, and two permanent magnets 22 on the outer circumferential side which are located at both ends of the permanent magnet 22 on the inner circumferential side separately therefrom. Two permanent magnets 22 on the outer circumferential side have magnetic flux generation surfaces in directions along the radial direction. The eddy current suppression member 25 is provided on the inner circumferential side of the magnetic flux generation surface of the permanent magnet 22 on the inner circumferential side with the insulating member 24 interposed therebetween.

In the permanent magnet-type rotary electric machine according to the present embodiment, the width of the permanent magnet 22 on the inner circumferential side is 20 mm. From the relationship of the loss cross frequency with respect to the width of the permanent magnet shown in FIG. 5 in embodiment 1, the loss cross frequency when the width of the permanent magnet is 20 mm is 1.9 kHz. In this permanent magnet-type rotary electric machine, if the carrier frequency in PWM control is set at 1.9 kHz or higher, eddy current losses in the permanent magnet and the eddy current suppression member on the inner circumferential side can be suppressed.

As described above, in the permanent magnet-type rotary electric machine driving system of the present embodiment, it is possible to suppress eddy current loss in the entire rotor by performing driving at a frequency higher than the loss cross frequency determined by the width of the permanent magnet on the inner circumferential side.

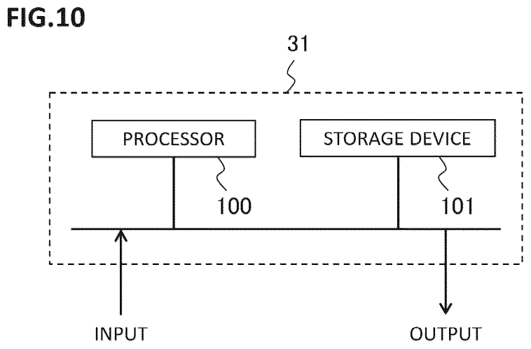

As shown in a hardware example in FIG. 10, the control device 31 includes a processor 100 and a storage device 101. The storage device is provided with a volatile storage device such as a random access memory and a nonvolatile auxiliary storage device such as a flash memory, which are not shown. Instead of the flash memory, an auxiliary storage device of a hard disk may be provided. The processor 100 executes a program inputted from the storage device 101. In this case, a program is inputted from the auxiliary storage device to the processor 100 via the volatile storage device. The processor 100 may output data such as a calculation result to the volatile storage device of the storage device 101, or may store such data into the auxiliary storage device via the volatile storage device.

Although the disclosure is described above in terms of various exemplary embodiments, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 permanent magnet-type rotary electric machine
2 rotary shaft
3 permanent magnet-type rotary electric machine driving system
10 stator
11 stator core
12 stator coil
13 core back
14 tooth
20 rotor
21 rotor core
22 permanent magnet
23 flux barrier
24 insulating member
25 eddy current suppression member
30 inverter
31 control device
32 DC power supply
100 processor
101 storage device

1. A permanent magnet-type rotary electric machine driving system comprising:
a permanent magnet-type rotary electric machine including a stator having an annular-shaped stator core and a stator coil wound at the stator core, and a rotor having a rotor core fastened to a rotary shaft and a plurality of permanent magnets buried in the rotor core;
an inverter which outputs driving power to the stator coil; and
a controller which designates a carrier frequency for the inverter and controls an output of the inverter, wherein
the plurality of permanent magnets are provided so as to be arranged in a circumferential direction, and an eddy current suppression member is provided at a magnetic flux generation surface of at least one of the permanent magnets with an insulating member interposed therebetween, and
where, in a cross-section along a plane perpendicular to the rotary shaft, a length in a longitudinal direction of the magnetic flux generation surface of the one permanent magnet is a width d₁, a length in a depth direction of the magnetic flux generation surface of the one permanent magnet is h₁, an electric conductivity of the one permanent magnet is Gi, a magnetic permeability of the one permanent magnet is μ₁, a length in a longitudinal direction of a surface opposed to the one permanent magnet, of the eddy current suppression member, is a width d₂, a length in a depth direction of the surface opposed to the one permanent magnet, of the eddy current suppression member, is h₂, an electric conductivity of the eddy current suppression member is σ₂, and a magnetic permeability of the eddy current suppression member is μ₂,
the controller designates the carrier frequency greater than a frequency f calculated from the following seven formulae:
$$\begin{matrix}[ Mathematical 14 ] & \\ {δ}_{1} = \sqrt{\frac{1}{π f {σ}_{1} {μ}_{1}}} , & \end{matrix}$$
$$\begin{matrix}[ Mathematical 15 ] & \\ {δ}_{2} = \sqrt{\frac{1}{π f {σ}_{2} {μ}_{2}}} , & \end{matrix}$$
$$\begin{matrix}[ Mathematical 16 ] & \\ A ( {d}_{1} / {δ}_{1} ) = \frac{sinh ( {d}_{1} / {δ}_{1} ) + sin ( {d}_{1} / {δ}_{1} )}{cosh ( {d}_{1} / {δ}_{1} ) - cos ( {d}_{1} / {δ}_{1} )} , & \end{matrix}$$
$$\begin{matrix}[ Mathematical 17 ] & \\ A ( {d}_{2} / {δ}_{2} ) = \frac{sinh ( {d}_{2} / {δ}_{2} ) + sin ( {d}_{2} / {δ}_{2} )}{cosh ( {d}_{2} / {δ}_{2} ) - cos ( {d}_{2} / {δ}_{2} )} , & \end{matrix}$$
$$\begin{matrix}[ Mathematical 18 ] & \\ B ( {d}_{1} / {δ}_{1} ) = \frac{sinh ( {d}_{1} / {δ}_{1} ) - sin ( {d}_{1} / {δ}_{1} )}{cosh ( {d}_{1} / {δ}_{1} ) - cos ( {d}_{1} / {δ}_{1} )} , & \end{matrix}$$
$$\begin{matrix}[ Mathematical 19 ] & \\ B ( {d}_{2} / {δ}_{2} ) = \frac{sinh ( {d}_{2} / {δ}_{2} ) - sin ( {d}_{2} / {δ}_{2} )}{cosh ( {d}_{2} / {δ}_{2} ) - cos ( {d}_{2} / {δ}_{2} )} , \\ and & \end{matrix}$$
$$\begin{matrix}[ Mathematical 20 ] & \\ \frac{{h}_{1} {σ}_{1} {δ}_{1} B ( {d}_{1} / {δ}_{1} )}{{\{ \frac{{h}_{1}}{{μ}_{1}} \frac{d}{2 {δ}_{1}} A ( {d}_{1} / {δ}_{1} ) \}}^{2} + {\{ \frac{{h}_{1}}{{μ}_{1}} \frac{d}{2 {δ}_{1}} B ( {d}_{1} / {δ}_{1} ) \}}^{2}} = \frac{{h}_{1} {σ}_{1} {δ}_{1} B ( {d}_{1} / {δ}_{1} ) + {h}_{2} {σ}_{2} {δ}_{2} B ( {d}_{2} / {δ}_{2} )}{\begin{matrix}{\{ \frac{{h}_{1}}{{μ}_{1}} \frac{d}{2 {δ}_{1}} A ( {d}_{1} / {δ}_{1} ) + \frac{{h}_{2}}{{μ}_{2}} \frac{d}{2 {δ}_{2}} A ( {d}_{2} / {δ}_{2} ) \}}^{2} + \\ {\{ \frac{{h}_{1}}{{μ}_{1}} \frac{d}{2 {δ}_{1}} B ( {d}_{1} / {δ}_{1} ) + \frac{{h}_{2}}{{μ}_{2}} \frac{d}{2 {δ}_{2}} B ( {d}_{2} / {δ}_{2} ) \}}^{2}\end{matrix}} . & \end{matrix}$$

2. The permanent magnet-type rotary electric machine driving system according to claim 1, wherein
the rotor has a plurality of magnetic poles, and each of the magnetic poles has a multilayer structure in which pairs of two of the permanent magnets are arranged in V shapes.

3. The permanent magnet-type rotary electric machine driving system according to claim 2, wherein
in each of the magnetic poles having the multilayer structures, the eddy current suppression member is provided at the permanent magnet in a layer on an innermost circumferential side with the insulating member interposed therebetween.

4. The permanent magnet-type rotary electric machine driving system according to claim 1, wherein
the stator coil wound at the stator core is wound in a distributed winding manner.

5. A permanent magnet-type rotary electric machine driving method for a permanent magnet-type rotary electric machine including a stator having an annular-shaped stator core and a stator coil wound at the stator core, and a rotor having a rotor core fastened to a rotary shaft and a plurality of permanent magnets buried in the rotor core, wherein,
the plurality of permanent magnets are provided so as to be arranged in a circumferential direction, and an eddy current suppression member is provided at a magnetic flux generation surface of at least one of the permanent magnets with an insulating member interposed therebetween, and
where, in a cross-section along a plane perpendicular to the rotary shaft, a length in a longitudinal direction of the magnetic flux generation surface of the one permanent magnet is a width d₁, a length in a depth direction of the magnetic flux generation surface of the one permanent magnet is h₁, an electric conductivity of the one permanent magnet is σ₁, a magnetic permeability of the one permanent magnet is μ₁, a length in a longitudinal direction of a surface opposed to the one permanent magnet, of the eddy current suppression member, is a width d₂, a length in a depth direction of the surface opposed to the one permanent magnet, of the eddy current suppression member, is h₂, an electric conductivity of the eddy current suppression member is σ₂, and a magnetic permeability of the eddy current suppression member is μ₂,
the stator coil is driven with a carrier frequency greater than a frequency f calculated from the following seven formulae:
$$\begin{matrix}[ Mathematical 21 ] & \\ {δ}_{1} = \sqrt{\frac{1}{π f {σ}_{1} {μ}_{1}}} , & \end{matrix}$$
$$\begin{matrix}[ Mathematical 22 ] & \\ {δ}_{2} = \sqrt{\frac{1}{π f {σ}_{2} {μ}_{2}}} , & \end{matrix}$$
$$\begin{matrix}[ Mathematical 23 ] & \\ A ( {d}_{1} / {δ}_{1} ) = \frac{sinh ( {d}_{1} / {δ}_{1} ) + sin ( {d}_{1} / {δ}_{1} )}{cosh ( {d}_{1} / {δ}_{1} ) - cos ( {d}_{1} / {δ}_{1} )} , & \end{matrix}$$
$$\begin{matrix}[ Mathematical 24 ] & \\ A ( {d}_{2} / {δ}_{2} ) = \frac{sinh ( {d}_{2} / {δ}_{2} ) + sin ( {d}_{2} / {δ}_{2} )}{cosh ( {d}_{2} / {δ}_{2} ) - cos ( {d}_{2} / {δ}_{2} )} , & \end{matrix}$$
$$\begin{matrix}[ Mathematical 25 ] & \\ B ( {d}_{1} / {δ}_{1} ) = \frac{sinh ( {d}_{1} / {δ}_{1} ) - sin ( {d}_{1} / {δ}_{1} )}{cosh ( {d}_{1} / {δ}_{1} ) - cos ( {d}_{1} / {δ}_{1} )} , & \end{matrix}$$
$$\begin{matrix}[ Mathematical 26 ] & \\ B ( {d}_{2} / {δ}_{2} ) = \frac{sinh ( {d}_{2} / {δ}_{2} ) - sin ( {d}_{2} / {δ}_{2} )}{cosh ( {d}_{2} / {δ}_{2} ) - cos ( {d}_{2} / {δ}_{2} )} , \\ and & \end{matrix}$$
$$\begin{matrix}[ Mathematical 27 ] & \\ \frac{{h}_{1} {σ}_{1} {δ}_{1} B ( {d}_{1} / {δ}_{1} )}{{\{ \frac{{h}_{1}}{{μ}_{1}} \frac{d}{2 {δ}_{1}} A ( {d}_{1} / {δ}_{1} ) \}}^{2} + {\{ \frac{{h}_{1}}{{μ}_{1}} \frac{d}{2 {δ}_{1}} B ( {d}_{1} / {δ}_{1} ) \}}^{2}} = \frac{{h}_{1} {σ}_{1} {δ}_{1} B ( {d}_{1} / {δ}_{1} ) + {h}_{2} {σ}_{2} {δ}_{2} B ( {d}_{2} / {δ}_{2} )}{\begin{matrix}{\{ \frac{{h}_{1}}{{μ}_{1}} \frac{d}{2 {δ}_{1}} A ( {d}_{1} / {δ}_{1} ) + \frac{{h}_{2}}{{μ}_{2}} \frac{d}{2 {δ}_{2}} A ( {d}_{2} / {δ}_{2} ) \}}^{2} + \\ {\{ \frac{{h}_{1}}{{μ}_{1}} \frac{d}{2 {δ}_{1}} B ( {d}_{1} / {δ}_{1} ) + \frac{{h}_{2}}{{μ}_{2}} \frac{d}{2 {δ}_{2}} B ( {d}_{2} / {δ}_{2} ) \}}^{2}\end{matrix}} . & \end{matrix}$$

6. The permanent magnet-type rotary electric machine driving system according to claim 2, wherein
the stator coil wound at the stator core is wound in a distributed winding manner.

7. The permanent magnet-type rotary electric machine driving system according to claim 3, wherein
the stator coil wound at the stator core is wound in a distributed winding manner.
